(19) United States
(12) Patent Application Publication
(10) Pub. No.: US 2023/0350715 A1
(43) Pub. Date: Nov. 2, 2023

(54) Identifying Memory System Sensitivity to Timing Parameters

(71) Applicant: Advanced Micro Devices, Inc., Santa Clara, CA (US)

(72) Inventors: Joshua Taylor Knight, Georgetown, TX (US); Jayesh Hari Joshi, Austin, TX (US); Anil Harwani, Austin, TX (US); Grant Evan Ley, Eden, UT (US); Jerry Anton Ahrens, Sister Bay, WI (US); William Robert Alverson, Del Valle, TX (US); Amitabh Mehra, Fort Collins, CO (US)

(73) Assignee: Advanced Micro Devices, Inc., Santa Clara, CA (US)

(21) Appl. No.: 17/732,987

(22) Filed: Apr. 29, 2022

(51) Int. Cl. G06F 9/50; G06F 11/34

(52) U.S. Cl. CPC G06F 9/5016; G06F 9/505; G06F 9/5044; G06F 11/3409

(57) ABSTRACT

Various timing parameter values for a memory system are changed and a workload is run using the changed timing parameter values resulting in workload performance values. The workload is run multiple times with different timing parameter values and the performance values generated by the workload are used to generate and output a performance indication that identifies how sensitive performance of the physical memory is to the one or more timing parameters. The parameter values generated by the workload are optionally used to predict what parameter value the workload would have generated for user selected timing parameter values (e.g., without running the workload).

### BACKGROUND

Modern memory systems have various different timing parameters that are configurable. Changing the values for these timing parameters has various results, positive or negative, such as improving the performance of the memory system or making the memory system nonfunctional.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a non-limiting example system that is operable to employ the identifying memory system sensitivity to timing parameters described herein.

FIG. 2 illustrates an example architecture of a performance scoring system.

FIG. 3 illustrates an example computing device outputting a performance indication.

FIG. 4 illustrates another example architecture of a performance scoring system.

FIG. 5 illustrates an example computing device outputting a predicted performance score.

FIG. 6 is a flow diagram depicting a procedure in an example implementation of identifying memory system sensitivity to timing parameters.

### DETAILED DESCRIPTION

Overview

Many memory systems have various different timing parameters that are configurable. Changing the values for these timing parameters has various results that change the performance of the memory system, such as latency of the memory system, bandwidth of the memory system, power usage of the memory system, and so forth. As there are numerous different timing parameters, users oftentimes have difficulty knowing which one or more timing parameters to change in order to get the result they desire (e.g., increased performance, reduced power usage, etc.). Furthermore, in some situations users make a change that leaves the memory system nonfunctional, a predicament from which it is difficult for the user to recover.

The techniques discussed herein allow various timing parameter values for a memory system to be changed and a workload executed (also referred to as run) using the changed timing parameter values. The workload generates performance values using the changed timing parameter values. This process is automatically repeated multiple times for various timing parameters and various values for those timing parameters. The performance values generated by the workload are used to generate a performance indication that identifies how sensitive performance of the physical memory is to the one or more timing parameters. The performance indication allows the user to readily identify which one or more timing parameters have the most affect on the memory system performance that he is interested in, allowing the user to then focus on adjusting timing parameter values for those one or more timing parameters. This frees the user from needing to guess or take a trial and error approach to determine the one or more timing parameters to adjust to achieve the improved performance that he desires. Furthermore, the timing parameter values are set within a range of values that will keep the memory system functional (e.g., a safe range). This allows the one or more timing parameters having the most affect on the memory system performance that the user is interested to be identified without any risk of rendering the memory system nonfunctional.

Furthermore, the techniques discussed herein are able to predict how various timing parameter value changes would affect the memory system. Given the performance values generated by the workload for one or more timing parameters, e.g., by using the performance values to extract a predicted performance value that the workload would have generated for a given timing parameter value. For example, a user is able to select timing parameter values (e.g., that are not being used by the current memory system or not supported entirely) and receive a prediction of what performance value the workload would have generated for the selected timing parameter values. This allows, for example, the user to evaluate how changes to the memory system (e.g., an upgraded or faster physical memory) would affect the performance values generated by the workload without having to expend the time or resources to purchase and install new components (e.g., an upgraded or faster physical memory).

In some aspects, the techniques described herein relate to a method including: identifying one or more timing parameters for accessing physical memory of a memory system; running a workload multiple times, each time with a different value for the one or more timing parameters; generating a performance indication that identifies how sensitive performance of the memory system is to the one or more timing parameters; and outputting the performance indication.

In some aspects, the techniques described herein relate to a method, the generating the performance indication including generating the performance indication by determining how much each change of a particular value in each of the one or more timing parameters changes a performance value generated by the workload.

In some aspects, the techniques described herein relate to a method, the one or more timing parameters including multiple timing parameters, the generating the performance indication including generating the performance indication by ordering the multiple timing parameters in an order from a timing parameter of the multiple timing parameters that resulted in a change in a performance value of the workload the most to a timing parameter of the multiple timing parameters that resulted in a change in the performance value of the workload by the least.

In some aspects, the techniques described herein relate to a method, further including receiving user input identifying the workload.

In some aspects, the techniques described herein relate to a method, further including receiving user input identifying the one or more timing parameters.

In some aspects, the techniques described herein relate to a method, further including selecting, for each execution of the workload, a value for the one or more timing parameters that is within a range of values that do not result in the memory system becoming nonfunctional.

In some aspects, the techniques described herein relate to a method, further including: receiving user input of a particular value for a particular timing parameter of the one or more timing parameters; predicting a performance value the workload would have generated had the workload been run with the particular timing value; and displaying the predicted performance value.

In some aspects, the techniques described herein relate to a method, wherein the performance of the memory system includes bandwidth of the memory system.

In some aspects, the techniques described herein relate to a method, wherein the performance of the memory system includes latency of the memory system.

In some aspects, the techniques described herein relate to a method, wherein the performance of the memory system includes power usage of the memory system.

In some aspects, the techniques described herein relate to a system including: a memory setting module to identify one or more timing parameters for accessing physical memory of a memory system and set the one or more timing parameters with a different value for each of multiple executions of a workload; and a workload evaluation module to generate and output a performance indication that identifies how sensitive performance of the memory system is to the one or more timing parameters.

In some aspects, the techniques described herein relate to a system, wherein to generate the performance indication is to generate the performance indication by determining how much each change of a particular value in each of the one or more timing parameters changes a performance value generated by the workload.

In some aspects, the techniques described herein relate to a system, wherein the memory setting module is further to select, for each execution of the workload, a value for the one or more timing parameters that is within a range of values that do not result in the memory system becoming nonfunctional.

In some aspects, the techniques described herein relate to a system, further including a prediction module to receive user input of a particular value for a particular timing parameter of the one or more timing parameters, predict a performance value the workload would have generated had the workload been run with the particular timing value, and output the predicted performance value.

In some aspects, the techniques described herein relate to a system, wherein the performance of the memory system includes one or more of bandwidth of the memory system, latency of the memory system, and power usage of the memory system.

In some aspects, the techniques described herein relate to a computing device including: a memory system; and a performance scoring system to identify one or more timing parameters for accessing physical memory of the memory system, set the one or more timing parameters with a different value for each running of a workload, generate a performance indication that identifies how sensitive performance of the memory system is to the one or more timing parameters, and output the performance indication.

In some aspects, the techniques described herein relate to a computing device, wherein to generate the performance indication is to generate the performance indication by determining how much each change of a particular value in each of the one or more timing parameters changes a performance value generated by the workload.

In some aspects, the techniques described herein relate to a computing device, wherein the performance scoring system is further to select, for each execution of the workload, a value for the one or more timing parameters that is within a range of values that do not result in the memory system becoming nonfunctional.

In some aspects, the techniques described herein relate to a computing device, wherein the performance scoring system further includes a prediction module to receive user input of a particular value for a particular timing parameter of the one or more timing parameters, predict a performance value the workload would have generated had the workload been run with the particular timing value, and output the predicted performance value.

In some aspects, the techniques described herein relate to a computing device, wherein the performance of the memory system includes one or more of bandwidth of the memory system, latency of the memory system, and power usage of the memory system.

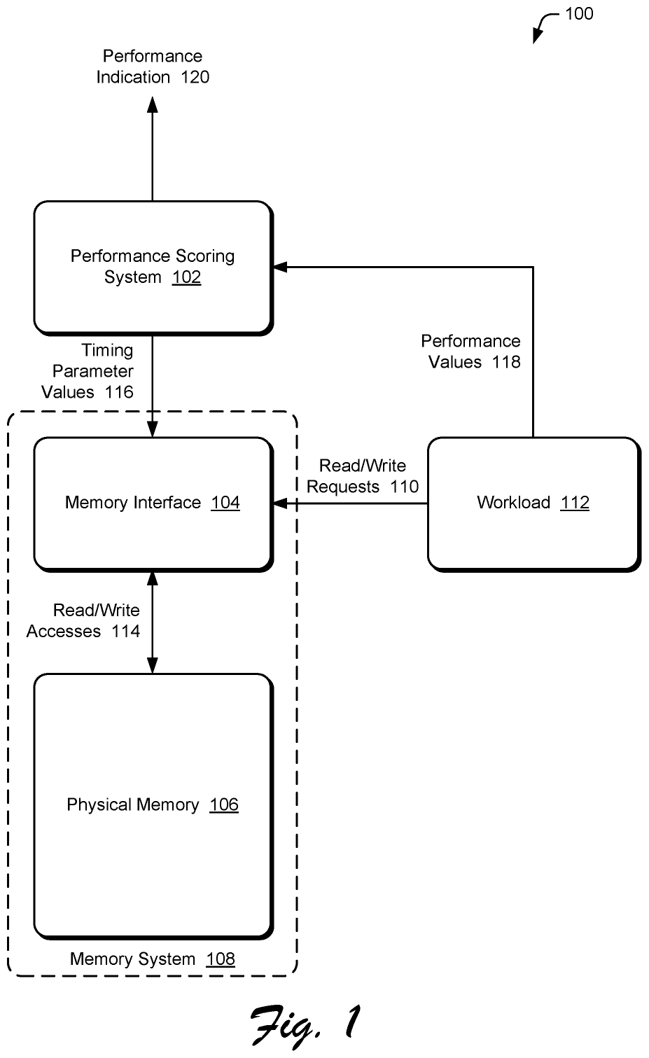

FIG. 1 is an illustration of a non-limiting example system 100 that is operable to employ the identifying memory system sensitivity to timing parameters described herein. The system 100 includes various components including a performance scoring system 102, a memory interface 104, and a physical memory 106. The memory interface 104 and the physical memory are also collectively referred to as the memory system 108. The physical memory 106 is any of a variety of volatile memory, such as dynamic random access memory (DRAM). Additionally or alternatively, the physical memory is any of a variety of nonvolatile memory, such as resistive random access memory (e.g., memristors).

The memory interface 104 manages reading data from and writing data to the physical memory 106. The memory interface 104 is, for example, a memory controller that receives read and write requests 110 from a workload 112 and performs the corresponding read or write access 114 to the physical memory 106, returning any appropriate data (e.g., the requested data for a read access). The workload 112 is one or more programs that assess or evaluate the performance of the memory system 108. In one or more implementations, the workload 112 is a benchmark program that runs one or more tests of the memory system 108 or a processor (e.g., a central processing unit (CPU)) accessing the memory system 108.

The memory interface 104 includes multiple different timing parameters that describe how the memory interface 104 interacts with the physical memory 106. These timing parameters include, for example, parameters related to reading data from the physical memory 106, parameters related to writing data to the physical memory 106, parameters related to refreshing the physical memory 106, and so forth. Examples of these timing parameters include an active to active delay time within the same bank group (e.g., tRRDL), an active to active delay time to a different bank group (e.g., tRRDS), a four active window time (e.g., tFAW), a write recovery time (e.g., tWR), a time between sending a column address and the response (e.g., CAS), a row address strobe (RAS) to column address strobe (CAS) delay time (e.g., tRCD), a row precharge delay time (e.g., tRP), a active to precharge delay time (e.g., tRAS), a CAS latency time (e.g., tAA), an active to active/refresh delay time (tRC), a refresh recovery delay time in a normal refresh mode (tRFC1), a refresh recovery delay time in a fine granularity refresh mode (tRFC2), a refresh recovery delay time in a same bank refresh mode (tRFCs), a write to read command delay second within a same bank group (tWTRL), a write to read command delay second within a different bank group (tWTRS), a read to precharge delay (tRTP), and so forth.

The performance scoring system 102 provides one or more timing parameter values 116 to the memory interface 104. Which timing parameters are changed, and the values used in changing those timing parameters, is determined in any of a variety of different manners as discussed in more detail below. In some situations, the changing of timing parameter values is also referred to as overclocking the memory system 108.

The workload 112 is run with the timing parameter values 116 and various read and write requests 110 are made to the memory system 108. The workload 112 generates one or more performance values 118, which are provided to the performance scoring system 102. Different workloads 112 generate performance values 118 that identify different types of performance, such as latency of the memory system 108, bandwidth of the memory system 108, power usage of the memory system 108 (e.g., battery life for a notebook or other portable device, power for performance per watt calculations for a desktop computer), and so forth.

The performance scoring system 102 evaluates performance values 118 and generates a performance indication 120 indicating how sensitive performance of the memory system 108 is to the one or more timing parameters that were changed. The performance indication 120 is output to any of various different devices or entities. In one example, the performance indication 120 is output to a display device, allowing a user of the system 100 to see how sensitive performance of the memory system 108 is to the one or more timing parameters that were changed. Additionally or alternatively, an indication derived from the performance indication 120 that shows general sensitivity of the memory system to one or more timing parameters that were changed (e.g., a grade, a heatmap, and so forth as discussed in more detail below) is output to a display device or another application or system. Additionally or alternatively, the performance indication 120 is output to another application or system that uses the performance indication 120 to determine which timing parameter values to change in order to improve performance of memory system 108 (e.g., overclock the memory system 108).

In one or more implementations the performance scoring system 102 changes each of multiple different timing parameters multiple times and the workload 112 generates the one or more performance values 118 for the new timing parameter values 116 after each change. This allows the performance scoring system 102 to generate one or more performance indications identifying which timing parameters the memory system 108 is most (and least) sensitive to for the workload 112.

It should be noted that although a single workload 112 is illustrated in the system 100, any number of workloads 112 are includable in the system 100. In one or more implementations, the performance scoring system 102 generates one or more performance indications 120 for each different workload 112. Additionally or alternatively, the performance scoring system 102 generates one or more generic or combined performance indications 120 for the multiple different workloads 112.

The system 100 is implementable in any of a variety of different types of computing devices that include or use physical memory 106. For example, the system 100 is implementable in a smartphone or other wireless phone, a tablet or phablet computer, a notebook computer (e.g., netbook or ultrabook), a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television), an Internet of Things (IoT) device, an automotive computer, and so forth.

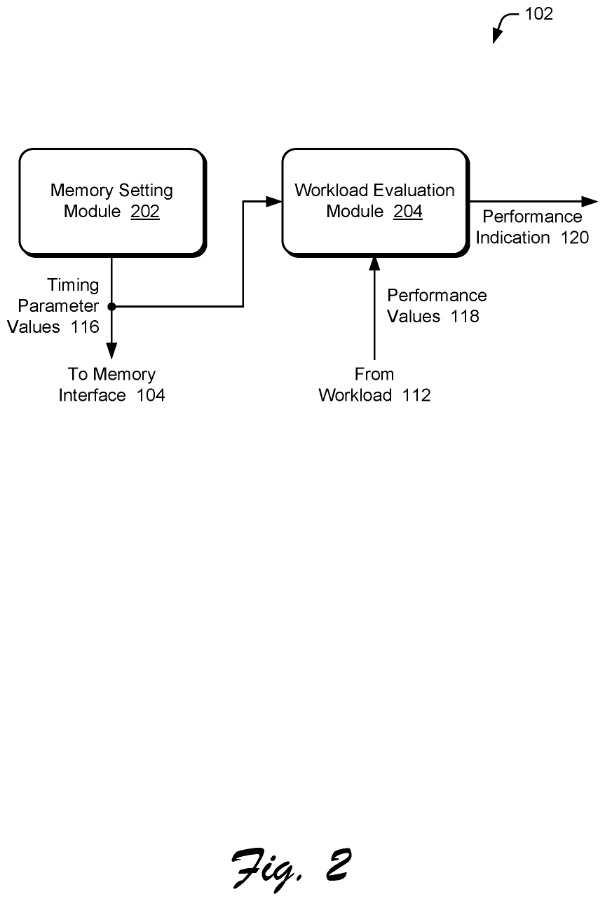

FIG. 2 illustrates an example architecture of the performance scoring system 102. The performance scoring system 102 includes a memory setting module 202 and a workload evaluation module 204. The memory setting module 202 provides one or more timing parameter values 116 to the memory interface 104.

As discussed above, the memory interface 104 includes various different timing parameters that are changeable. Which timing parameters are changed is determined in any of a variety of different manners. In one or more implementations, the memory setting module 202 is configured with a set of one or more default timing parameters that are changed. Additionally or alternatively, the memory setting module 202 receives user input specifying which one or more timing parameters are to be changed. Additionally or alternatively, the memory setting module 202 obtains data from one or more external sources (e.g., an original design manufacturer (ODM) of the physical memory 106 or the memory interface 104) indicating which one or more timing parameters are to be changed. Additionally or alternatively, the memory setting module 202 obtains an indication from the workload 112 of which one or more timing parameters are to be changed.

The values to be used for the one or more parameters are determined in any of a variety of different manners. In one or more implementations, the memory setting module 202 is configured with one or more default values to use for each timing parameter. Additionally or alternatively, the memory setting module 202 receives user input specifying one or more values to use for each timing parameter. Additionally or alternatively, the memory setting module 202 obtains data from one or more external sources (e.g., an ODM of the physical memory 106 or the memory interface 104) indicating one or more values to use for each timing parameter. Additionally or alternatively, the memory setting module 202 obtains an indication from the workload 112 of one or more values to use for each timing parameter.

In one or more implementations, the memory setting module 202 restricts the values for each timing parameter so that the values are within a safe range. A safe range refers to a range of values (e.g., ranging from a minimum value to a maximum value) that will keep the memory system 108 functional. Accordingly, the memory setting module 202 prevents a timing parameter from being set to a value that would make the memory system 108 nonfunctional. The safe range for each timing parameter is determined in any of a variety of manners analogous to determining the value for each timing parameter.

The workload 112 runs with the timing parameter values 116, generating one or more performance values 118 that are provided to the performance scoring system 102. The workload 112 is run multiple times with different timing parameter values 116. The workload evaluation module 204 keeps a record of the performance values 118 from each time the workload 112 is run and generates the performance indication 120 from the various performance values 118.

The memory setting module 202 changes any combination of timing parameters and timing parameter values for each time the workload 112 is run. In one or more implementations, the memory setting module 202 changes the timing parameter value for a single timing parameter (e.g., leaving all other timing parameters at a default value) for each running of the workload 112. This allows the workload evaluation module 204 to generate a performance indication 120 that better identifies how a single timing parameter affects the performance values 118 generated by the workload 112. Information regarding the performance of the memory system 108 (e.g., performance values 118) is generated by any of various entities, such as by the workload 112 itself or any of various hardware performance counters or activity monitors in the computing device implementing the system 100 (e.g., on a chip implementing the memory interface 104).

The memory setting module 202 optionally runs the workload 112 multiple times, each time with a different value for the timing parameter. For example, the memory setting module 202 runs the workload 112 twice, once with each of two different values for the timing parameter. The different performance values 118 resulting from running the workload 112 with different timing parameter values 116 allows the workload evaluation module 204 to generate the performance indication 120 as discussed in more detail below.

In one or more implementations, the memory setting module 202 selects timing parameter values to use that are within the safe range for the timing parameter. These timing parameter values are selected in any of a variety of manners. In one example, the memory setting module 202 selects the minimum safe value for the timing parameter and the maximum safe value for the timing parameter. By way of another example, the memory setting module 202 selects a value between (e.g., approximately half-way between) a current value for the timing parameter and the minimum safe value for the timing parameter, and selects another value between (e.g., approximately half-way between) a current value for the timing parameter and the maximum safe value for the timing parameter.

Additionally or alternatively, the memory setting module 202 changes the timing parameter values for a set of multiple timing parameters (e.g., leaving all other timing parameters at a default value) for each running of the workload 112. This allows the workload evaluation module 204 to generate a performance indication 120 that better identifies how that set of multiple timing parameters affects the performance values 118 generated by the workload 112.

In one or more implementations, for each set of multiple parameter values that are changed for the running of the workload 112, the memory setting module 202 runs the workload 112 twice, once with each of two different settings.

The memory setting module 202 optionally runs the workload 112 multiple times, each time with different values for the set of multiple timing parameters. For example, the memory setting module 202 runs the workload 112 twice, once with each timing parameter in the set of multiple time periods having one of two different values for the timing parameter. The different performance values 118 resulting from running the workload 112 with the different timing parameter values 116 allows the workload evaluation module 204 to generate the performance indication 120 as discussed in more detail below.

In one or more implementations, the memory setting module 202 selects timing parameter values to use that are within the safe range for the set of multiple timing parameters. These timing parameter values are selected in any of a variety of manners. In one example, the memory setting module 202 selects, for each timing parameter in the set of multiple timing parameters, the minimum safe value for the timing parameter and the maximum safe value for the timing parameter. By way of another example, the memory setting module 202 selects, for each timing parameter in the set of multiple timing parameters, a value between (e.g., approximately half-way between) a current value for the timing parameter and the minimum safe value for the timing parameter, and selects another value between (e.g., approximately half-way between) a current value for the timing parameter and the maximum safe value for the timing parameter.

The performance scoring system 102 evaluates performance values 118 and generates a performance indication 120 indicating how sensitive performance of the memory system 108 is to the one or more timing parameters that were changed. The workload evaluation module 204 also receives the different timing parameter values 116, so the workload evaluation module 204 is aware of which timing parameters were changed and what the timing parameter values were that resulted in the performance values 118. The workload evaluation module 204 generates the performance indication 120 in any of a variety of different manners.

In one or more implementations, the workload evaluation module 204 generates, as the performance indication 120, a numerical indication of the sensitivity of sensitive performance of the memory system 108 is to the one or more timing parameters that were changed. For example, the workload evaluation module 204 readily determines based on the different timing parameter values 116 that were used for a timing parameter and the resultant performance value 118, how much each change in the timing parameter value 116 alters the performance value 118. E.g., assume a change in timing parameter value 116 of 1 results in a 2% change in the performance value 118. The workload evaluation module 204 uses this change (e.g., 2%) as the performance indication 120.

Additionally or alternatively, the workload evaluation module 204 generates, as the performance indication 120, a ranked or ordered list of timing parameters. This ranking or ordering is, for example, the timing parameters that were changed and resulted in various performance values 118 in the order of changed timing parameters that improved the performance values 118 the most to the changed timing parameters that improved the performance values 118 the least.

Additionally or alternatively, the workload evaluation module 204 generates, as the performance indication 120, a list of timing parameters that satisfy one or more rules or criteria. The performance indication 120 uses any of a variety of rules or criteria, such as timing parameters that were changed and resulted in a performance value 118 that increased by a threshold percentage (e.g., 2%), that increased by a threshold amount (e.g., 500 on a scale of 1 to 30,000), that increased rather than decreased, and so forth.

Additionally or alternatively, the workload evaluation module 204 generates, as the performance indication 120, a grade for each timing parameter that was changed. Examples of such a grade include a letter grade (e.g., A through F), a numeric grade (e.g., 1 through 10), and so forth. The workload evaluation module 204 generates grades in various manners, such as any timing parameters that were changed and resulted in a performance value 118 that increased by one threshold percentage (e.g., 5%) or one threshold amount (e.g., 2500 on a scale of 1 to 30,000) are assigned a grade of A, any timing parameters that were not assigned a grade of A but were changed and resulted in a performance value 118 that increased by another threshold percentage (e.g., 3%) or another threshold amount (e.g., 1200 on a scale of 1 to 30,000) are assigned a grade of B, and so forth.

Additionally or alternatively, the workload evaluation module 204 generates, as the performance indication 120, a heatmap that shows general sensitivity of the memory system 108 to various timing parameters. In one example, a heatmap lays out the timing parameters (based on analysis of the workload 112 while being run) and, given the performance counters and activity detected while the workload 112 was run, such as by displaying timing parameters that would greatly influence scores in one manner (e.g., the color green) versus timing parameters that will likely not influence scores in another manner (e.g., the color red), and, e.g., a color heatmap in between. This could be an in between (e.g., interpolated) solution where the workload evaluation module 204 does not do a full analysis to predict exact scores but does analysis while the workload 112 is running to show how the memory system 108 as used and what parameters most influence improved outcome.

Additionally or alternatively, the workload evaluation module 204 generates, as the performance indication 120, an indication of the timing parameter that was changed that resulted in the largest increase in performance value 118.

In one or more implementations, the workload evaluation module 204 generates the performance indication 120 based on performance values 118 from a single workload 112. Additionally or alternatively, the workload evaluation module 204 generates the performance indication 120 based on performance values 118 from multiple workloads 112. In one example, the workload evaluation module 204 combines performance values 118 from different workloads 112 corresponding to the same timing parameter values 116 in the same timing parameter. This combination is performed in any of various manners, such as averaging the performance values 118, generating a weighted average of the performance values 118, and so forth. The workload evaluation module 204 generates the performance indication 120 in any of various manners as discussed above, but based on the combined performance values 118.

By way of another example, the workload evaluation module 204 generates the performance indication 120 based on the performance values 118 from the individual workloads 112 separately in any of various manners as discussed above. This results in multiple performance indications 120 being generated by the workload evaluation module 204. Output of the multiple performance indications 120 allows, for example, a user to see how changes to a timing parameter value affect multiple different workloads 112. E.g., assume one workload 112 generates performance values 118 that indicate changes in latency whereas another workload 112 generates performance values 118 that indicate changes in power usage. Including performance indications 120 for both workloads 112 allows a user to readily see, for example, the tradeoff between decreased latency and increased power usage for the different timing parameters.

In one or more implementations, the performance indication 120 allows a user of the system 100 to make more informed decisions when upgrading the memory system 108. For example, allowing a user to readily see which timing parameters most affect the performance (e.g., latency, bandwidth, or power usage) of the memory system 108 allows the user to select upgraded components (e.g., physical memory 106) that have better values for these timing parameters. This allows the user to know that he will receive better performance for components that have better values for these timing parameters because his memory system 108 is sensitive to these timing parameters.

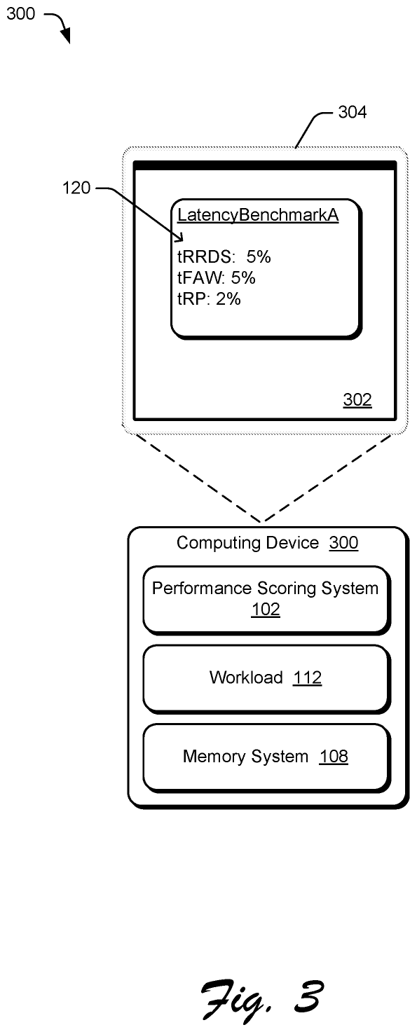

FIG. 3 illustrates an example computing device 300 outputting a performance indication. The computing device 300 is any of a variety of different types of computing devices that include or use physical memory. For example, the computing device 300 is implementable in a smartphone or other wireless phone, a tablet or phablet computer, a notebook computer, a laptop computer, a wearable device, an entertainment device, an IoT device, an automotive computer, and so forth.

The computing device 300 includes a performance scoring system 102, a workload 112, and a memory system 108 as discussed herein. The performance scoring system 102 generates a performance indication 120 as discussed herein, which is displayed on a user interface 302 of a display device 304. The performance indication 120 is generated from running of workload 112 named “LatencyBenchmarkA.” As illustrated, the performance indication 120 shows how much each change (e.g., of a value of 1) in one of multiple timing parameters alters the performance value generated by the workload 112. E.g., each change (e.g., of a value of 1) in the tRDDS changes the parameter value generated by the workload 112 by 5%, each change (e.g., of a value of 1) in tFAW changes the parameter value generated by the workload 112 by 5%, and each change (e.g., of a value of 1) in tRP changes the parameter value generated by the workload 112 by 2%.

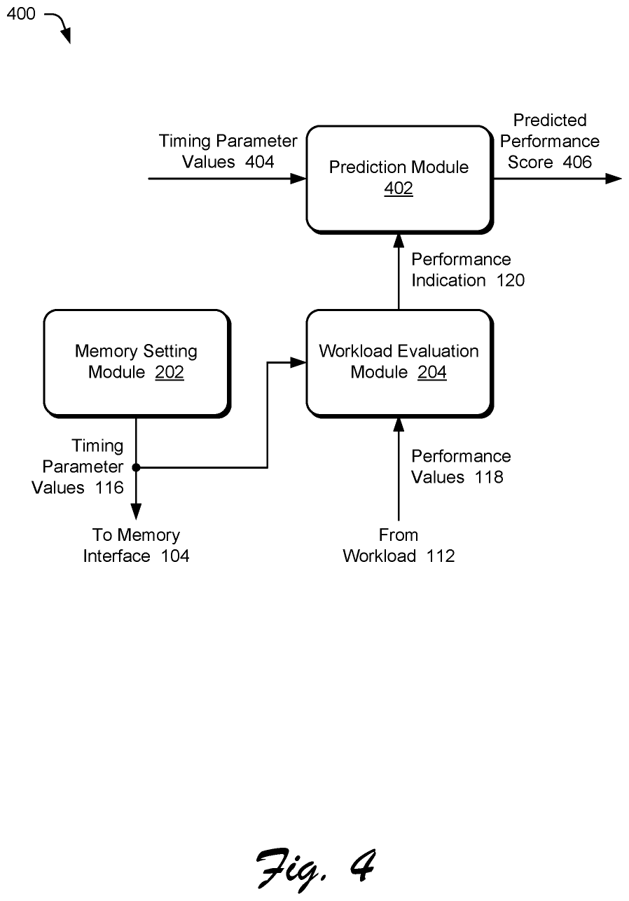

FIG. 4 illustrates another example architecture 400 of the performance scoring system 102. The performance scoring system 102 includes the memory setting module 202 and the workload evaluation module 204, which operate as discussed above (e.g., with to reference the performance scoring system 102 of FIG. 2). The architecture in FIG. 4 differs from the architecture in FIG. 2 in that the architecture in FIG. 4 includes a prediction module 402.

The prediction module 402 receives the performance indication 120 and timing parameter values 404, and generates a predicted performance score 406 (e.g., a simulated performance score). Although illustrated as being provided to the prediction module 402, additionally or alternatively the workload evaluation module 204 outputs the performance indication 120 to one or more other devices or entities (e.g., displays the performance indication 120 to a user of the system 100).

The prediction module 402 receives the timing parameter values 404 from any of various sources. In one or more implementations, the timing parameter values 404 are user inputs. Accordingly, a user of the system 100 provides the timing parameter values for the various timing parameters that he or she desires. Additionally or alternatively, the memory setting module 202 obtains data from one or more external sources (e.g., an ODM of the physical memory 106 or the memory interface 104) indicating one or more values to use for each of one or more timing parameters.

In one or more implementations, the workload evaluation module 204, based on the performance values 118 as discussed above, determines how much a change in timing parameter value 116 changes the performance value 118. The prediction module 402 readily uses this determined change to determine the predicted performance score 406 for one or more timing parameter values 404. In one example, the prediction module 402 extrapolates a predicted performance value that the workload 112 would have generated for a given timing parameter value 404. The prediction module 402 uses this predicted performance value as the predicted performance score 406, or generates a predicted performance score 406 based on the predicted performance value in the same manner as the workload evaluation module 204 uses the performance values 118 to generate performance indications 120.

For example, assume that for a given timing parameter, the workload evaluation module 204 determines how much a change in a value of that timing parameter changes the performance value 118. The workload evaluation module 204 provides this determined change to the prediction module 402 as at least part of the performance indication 120. In response to a user input identifying a particular timing parameter value 404, the prediction module 402 extrapolates what the performance value 118 would have been had the workload 112 run with the user-identified timing parameter value 404. The prediction module 402 outputs this extrapolated performance value as the predicted performance score 406.

Thus, for example, assume a user of the system 100 is interested in upgrading the physical memory 106 to higher performance memory. He or she notices that a particular timing parameter value for the upgraded physical memory is different than the timing parameter value of the physical memory 106. The user inputs the particular timing parameter value for the upgraded physical memory as timing parameter value 404, and the predicted performance score 406 gives the user a prediction of what the performance value 118 would have been had the workload 112 run with the particular timing parameter value for the upgraded physical memory. This allows the user to determine whether the increased performance is worth the cost of upgrading the physical memory without having to purchase and install the memory.

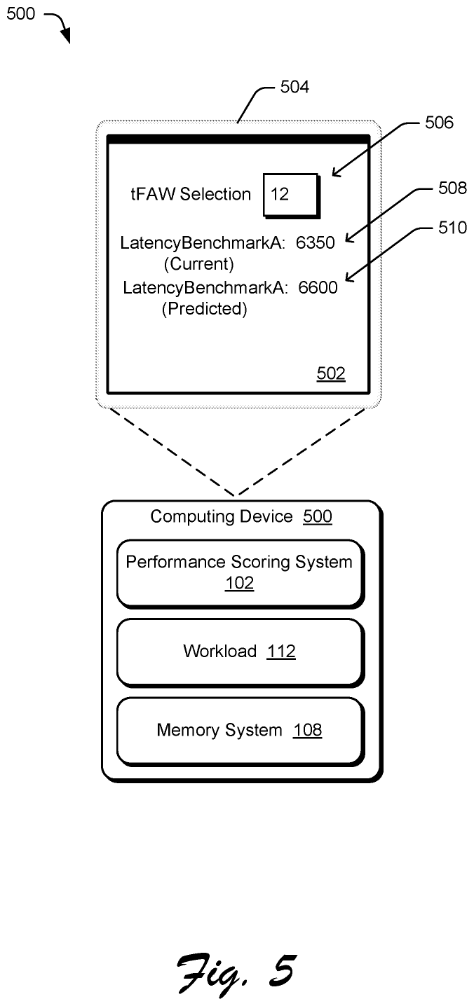

FIG. 5 illustrates an example computing device 500 outputting a predicted performance score. The computing device 500 is any of a variety of different types of computing devices that include or use physical memory. For example, the computing device 500 is implementable in a smartphone or other wireless phone, a tablet or phablet computer, a notebook computer, a laptop computer, a wearable device, an entertainment device, an IoT device, an automotive computer, and so forth.

The computing device 500 includes a performance scoring system 102, a workload 112, and a memory system 108 as discussed herein. The computing device 500 displays various data on a user interface 502 of a display device 504. The performance scoring system 102 receives a user-selected timing parameter value, illustrated at 506 as “12” for the timing parameter tFAW. The performance scoring system 102 displays a performance value 508 (e.g., a performance value 118 of FIG. 4) indicating the performance value generated using a current value (e.g., a value of 16) for the timing parameter tFAW when executing the workload 112. The performance scoring system 102 also displays a performance value 510 indicating the predicted performance value that would be generated if the workload 112 were executed using the user-selected value “12” for the timing parameter tFAW. Accordingly, the user is able to readily identify that if he were to upgrade the physical memory in memory system 108 to physical memory that supported a value of 12 for the timing parameter tFAW, expect the performance value generated by the workload 112 named “LatencyBenchmarkA” would increase from 6350 to approximately 6600.

The techniques discussed herein support a wide variety of usage scenarios. In one example usage scenario, a user uses the techniques discussed herein to identify timing parameter values to modify for his gaming computer to improve performance of the gaming computer by decreasing latency or increasing bandwidth. In another example, a user uses the techniques discussed herein to identify timing parameter values to modify for his smart TV to improve performance (e.g., power usage) for his smart TV. In another example, an ODM uses the techniques discussed herein to identify timing parameter values to modify for an embedded system to improve particular performance (e.g., latency, bandwidth, or power usage of a memory system on the embedded system).

Returning to FIG. 1, in one or more implementations, the performance scoring system 102 transmits one or both of the performance values 118 and the performance indications 120 to an external server or device (e.g., via the Internet). This transmission is done, for example, after receiving permission from the user of the device including the system 100. In such situations the performance scoring system 102 also transmits information describing the memory system 108 to the external server or device, such as a type of physical memory 106, an identifier of a make and model of the physical memory 106, an identifier of a make and model of the memory interface 104, and so forth. The external server or device analyzes this information collected from numerous users and provides any of a variety of information to devices including the system 100, with the information provided to a particular system varying based on the type of memory system 108 (e.g., type of physical memory 106, make and model of the physical memory 106 or the memory interface 104, and so forth).

In one example, the system 100 receives from the external server or device an indication of which timing parameters most affect performance values 118 for different workloads, allowing the performance scoring system 102 to notify a user of which timing parameters to modify to improve latency performance, which timing parameters to modify to improve bandwidth performance, which timing parameters to modify to improve power usage performance, and so forth. In another example, the performance scoring system 102 uses the indication of which timing parameters most affect performance values 118 for different workloads to automatically identify timing parameters for which timing parameter values are to be changed when generating the performance indication 120.

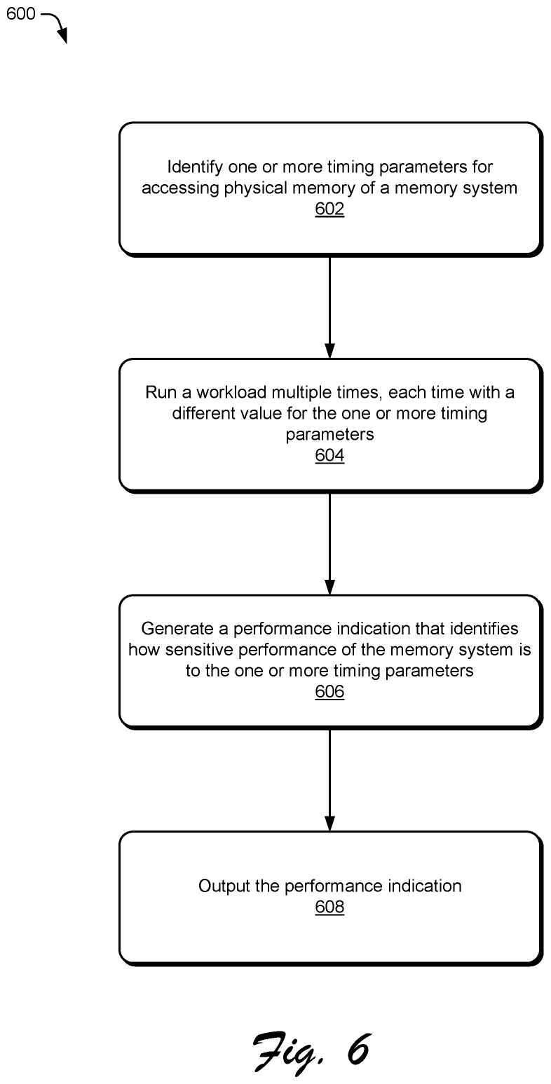

FIG. 6 is a flow diagram 600 depicting a procedure in an example implementation of identifying memory system sensitivity to timing parameters. The flow diagram 600 is performed by a performance scoring system such as performance scoring system 102 of FIG. 1, FIG. 2, or FIG. 4.

In this example, one or more timing parameters for accessing physical memory of a memory system are identified (block 602). These timing parameters are identified in various manners, such as receiving user input specifying the timing parameters, identifying default timing parameters, receiving an indication of the timing parameters from an ODM, and so forth.

A workload is run multiple times, each time with a different value for the one or more timing parameters (block 604). These values for the one or more timing parameters are within a safe range so that using these values for the one or more timing parameters does not render the memory system nonfunctional.

A performance indication that identifies how sensitive performance of the memory system is to the one or more timing parameters is generated (block 606). This performance indication takes any of various forms, such as an indication of how much a performance value generated by the workload changes in response to a change of the timing parameter value by a particular amount, a ranked or ordered list of timing parameters, a list of timing parameters that satisfy one or more rules or criteria, and so forth.

The performance indication is output (block 608). The performance indication is output in any of various manners, such as displaying the output, providing the output to a prediction module, and so forth.

The various functional units illustrated in the figures and/or described herein (including, where appropriate, the performance scoring system 102, the memory setting module 202, the workload evaluation module 204, and the prediction module 402) are implemented in any of a variety of different manners such as hardware circuitry, software executing or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
identifying one or more timing parameters for accessing physical memory of a memory system;
running a workload multiple times, each time with a different value for the one or more timing parameters;
generating a performance indication that identifies how sensitive performance of the memory system is to the one or more timing parameters; and
outputting the performance indication.

2. The method of claim 1, the generating the performance indication including generating the performance indication by determining how much each change of a particular value in each of the one or more timing parameters changes a performance value generated by the workload.

3. The method of claim 1, the one or more timing parameters including multiple timing parameters, the generating the performance indication comprising generating the performance indication by ordering the multiple timing parameters in an order from a timing parameter of the multiple timing parameters that resulted in a change in a performance value of the workload the most to a timing parameter of the multiple timing parameters that resulted in a change in the performance value of the workload the least.

4. The method of claim 1, further comprising receiving user input identifying the workload.

5. The method of claim 1, further comprising receiving user input identifying the one or more timing parameters.

6. The method of claim 1, further comprising selecting, for each execution of the workload, a value for the one or more timing parameters that is within a range of values that do not result in the memory system becoming nonfunctional.

7. The method of claim 1, further comprising:
receiving user input of a particular value for a particular timing parameter of the one or more timing parameters;
predicting a performance value the workload would have generated had the workload been run with the particular timing value; and
displaying the predicted performance value.

8. The method of claim 1, wherein the performance of the memory system comprises bandwidth of the memory system.

9. The method of claim 1, wherein the performance of the memory system comprises latency of the memory system.

10. The method of claim 1, wherein the performance of the memory system comprises power usage of the memory system.

11. A system comprising:
a memory setting module to identify one or more timing parameters for accessing physical memory of a memory system and set the one or more timing parameters with a different value for each of multiple executions of a workload; and
a workload evaluation module to generate and output a performance indication that identifies how sensitive performance of the memory system is to the one or more timing parameters.

12. The system of claim 11, wherein to generate the performance indication is to generate the performance indication by determining how much each change of a particular value in each of the one or more timing parameters changes a performance value generated by the workload.

13. The system of claim 11, wherein the memory setting module is further to select, for each execution of the workload, a value for the one or more timing parameters that is within a range of values that do not result in the memory system becoming nonfunctional.

14. The system of claim 11, further comprising a prediction module to receive user input of a particular value for a particular timing parameter of the one or more timing parameters, predict a performance value the workload would have generated had the workload been run with the particular timing value, and output the predicted performance value.

15. The system of claim 11, wherein the performance of the memory system comprises one or more of bandwidth of the memory system, latency of the memory system, and power usage of the memory system.

16. A computing device comprising:
a memory system; and
a performance scoring system to identify one or more timing parameters for accessing physical memory of the memory system, set the one or more timing parameters with a different value for each running of a workload, generate a performance indication that identifies how sensitive performance of the memory system is to the one or more timing parameters, and output the performance indication.

17. The computing device of claim 16, wherein to generate the performance indication is to generate the performance indication by determining how much each change of a particular value in each of the one or more timing parameters changes a performance value generated by the workload.

18. The computing device of claim 16, wherein the performance scoring system is further to select, for each execution of the workload, a value for the one or more timing parameters that is within a range of values that do not result in the memory system becoming nonfunctional.

19. The computing device of claim 16, wherein the performance scoring system further includes a prediction module to receive user input of a particular value for a particular timing parameter of the one or more timing parameters, predict a performance value the workload would have generated had the workload been run with the particular timing value, and output the predicted performance value.

20. The computing device of claim 16, wherein the performance of the memory system comprises one or more of bandwidth of the memory system, latency of the memory system, and power usage of the memory system.
